(19) United States
(12) Patent Application Publication
(10) Pub. No.: US 2015/0299428 A1
(43) Pub. Date: Oct. 22, 2015

(54) POLYCARBONATE COMPOSITION WITH IMPROVED OPTICAL PROPERTIES

(71) Applicant: Bayer Intellectual Property GmbH, Monheim (DE)

(72) Inventors: Rolf Erfinder WEHRMANN, Krefeld (DE); Helmut W. HEUER, Leverkusen (DE); Anke BOUMANS, Goch (DE)

(73) Assignee: BAYER INTELLECTUAL PROPERTY GMBH, Monheim (DE)

(21) Appl. No.: 14/388,454

(22) PCT Filed: Mar. 25, 2013
(86) PCT No.: PCT/EP2013/056319

§ 371 Date: Sep. 26, 2014

(30) Foreign Application Priority Data
Mar. 30, 2012 (EP) 12162343.3

(51) Int. Cl. C08K 5/50; C08K 3/00

(52) U.S. Cl. CPC C08K 5/50; C08K 3/0033

(57) ABSTRACT

The invention relates to a polycarbonate composition and copolycarbonate composition ((co)polycarbonates) with improved optical properties of the mouldings produced therefrom.

The invention relates to a composition of polycarbonate and of copolycarbonate ((co)polycarbonates) with improved optical properties of the moldings produced therefrom. The term polycarbonate composition hereinafter comprises not only homopolycarbonates but also copolycarbonates.

The invention relates in particular to compositions made of polycarbonate with one or more ionic liquids, where the polycarbonate is produced from bisphenols and organic carbonates by the transesterification process in the melt, the term used hereinafter being “melt polycarbonate”, or from bisphenols with phosgene in the interfacial process, preferably in a continuous interfacial process, and also by compounding.

Polycarbonate features not only good mechanical properties but also inter alia high transparency and color brilliance. One way of assessing color brilliance is what is known as the Yellowness Index (YI), which characterizes the degree of yellowing of the material. A low YI value is an important quality criterion for high-quality polycarbonate. Applications of bisphenol-A (BPA)-based polycarbonate cover a wide temperature range from −100° C. to about +135° C.

A low YI value is of great importance not only during the production process but also in the subsequent application. For color-critical applications of polycarbonate it is therefore desirable to produce polycarbonate moldings with low initial YI values and to achieve the lowest possible subsequent yellowing during subsequent use under conditions of thermal aging. Subsequent yellowing occurs by way of example in headlamp diffuser lenses made of polycarbonate which, depending on their size and shape, can have long-term exposure to temperatures above 100° C. Applications of this type require a material with a high level of optical properties that remain substantially unchanged, with minimized deterioration during the service time.

Polycarbonate can be produced by various processes. The first polycarbonate to achieve industrial importance was produced in solution by the interfacial process from bisphenols and phosgene (SPC). The transesterification process is achieving increasing importance nowadays, and reacts bisphenols with organic carbonates in the melt to give what is known as melt polycarbonate (MPC).

(Co)polycarbonates are moreover produced by means of compounding. For this, additives are incorporated into appropriate polymer melts, usually in a multiscrew extruder. This process is suitable for producing opaque and translucent, and also transparent, compositions.

The expression ionic liquids means molten salts, where these can be liquid at temperatures as low as room temperature. They are used in a variety of sectors, because they have particular properties.

An overview of ionic liquids is provided in P. Wasserscheid, W. Keim, Angew. Chem. Int. Ed. 2000, 39, 3772

DE 10 2008 049 787A1 relates to a process for the production of diphenyl carbonate with use of a catalyst composition comprising ionic liquids.

The dissertation by W. Wiesenhofer “Neue methoden zur Anwendung von Lipasen in der organischen Synthese [New Methods for the Use of Lipases in Organic Synthesis]; Ruhr-Universität Bochum, 2004” describes inter alia kinetic racemate separation in ionic liquids

It is known that ionic liquids can be very effective in dissipating heat from a reaction system (US 2006/0251961 A1)

US2010/0048829 A1 relates to liquid compositions which at least one polymer, and also one nitrogen-based ionic liquid (polycyclic amidine bases) for improved solubilization.

Ionic liquids are also described for applications in pressure-sensitive adhesives (US2005/266238 A1), in display applications (US2007/040982A1), or as ancillary entrainers in industrial distillation processes for the separation of azeotropic or narrow-boiling-range mixtures (WO 2005/016483 A1.

There is no description in the literature of applications of, or combinations of, ionic liquids with (co)polycarbonates or PC blends.

U.S. Pat. No. 6,372,829 B1 describes compositions made of at least one non-polymeric nitrogen-onium salt which includes a fluoro-organic anion. There is no description of the use of phosphorus-containing onium salts.

There was therefore a requirement for suitable polycarbonate molding compositions which, after processing to give moldings, have little intrinsic color (low YI value). This is particularly important for optical applications such as optical conductors, lenses, collimators, spectacles, headlamp lenses, optical data storage systems, housings, sheets, panels, or foils, (helmet) visors, or protective masks.

Surprisingly, however, it has been found that in particular ionic liquids have a very good effect on optical properties in polycarbonate molding compositions.

The invention therefore provides a polycarbonate composition which comprises a polycarbonate (component A), an ionic liquid (component B), and also at least one further additive from the heat and light stabilizers group (component C).

### Component A

Component A is a polycarbonate or a copolycarbonate.

For the purposes of the present invention, (co)polycarbonates are either homopolycarbonates or copolycarbonates; the polycarbonates can, as is known, be linear or branched.

Preferred production procedures for the polycarbonates to be used in the invention, inclusive of the polyester carbonates, are the known interfacial process and the known melt transesterification process.

In the first case, phosgene preferably serves as carbonic acid derivative, and in the latter case diphenyl carbonate preferably serves as carbonic acid derivative. In both cases there has been adequate description and disclosure of catalysts, solvents, work-up, reaction conditions, etc. for the production of polycarbonate.

Aromatic dicarboxylic ester groups can replace a portion, up to 80 mol %, preferably from 20 mol % up to 50 mol %, of the carbonate groups in the polycarbonates that are suitable in the invention. The correct term for polycarbonates of this type which comprise not only acid moieties from the carbonic acid but also acid moieties from aromatic dicarboxylic acids incorporated into the molecular chain is aromatic polyester carbonates. For simplicity in the present application they will be subsumed under the generic term “thermoplastic, aromatic polycarbonates”.

The process of the invention is in particular used in the production of polycarbonates. The present invention therefore also provides a process for the production of polycarbonates, characterized in that at least one step of the production process comprises an extrusion process of the invention.

The production of polycarbonates with the use of the process of the invention takes place in a known manner from diphenols, carbonic acid derivatives, optionally chain terminators, and optionally branching agents, where the polyester carbonates are produced by replacing a portion of the carbonic acid derivatives with aromatic dicarboxylic acids or with derivatives of the dicarboxylic acids, and specifically in accordance with the extent of carbonate structural units that are to be replaced by aromatic dicarboxylic ester structural units in the aromatic polycarbonates.

For the production of polycarbonates, reference may be made here by way of example to Schnell, “Chemistry and Physics of Polycarbonates”, Polymer Reviews, Volume 9, Interscience Publishers, New York, London, Sydney 1964.

The average molecular weight M_{w} of the thermoplastic polycarbonates preferably used in the process of the invention, inclusive of the thermoplastic, aromatic polyester carbonates, is from 12 000 to 120 000, preferably from 15 000 to 80 000, and in particular from 15 000 to 60 000 (determined via measurement of relative viscosity at 25° C. in CH₂Cl₂ at a concentration of 0.5 g per 100 ml of CH₂Cl₂).

Diphenols suitable for the process of the invention for the production of polycarbonate have been widely described in the prior art.

Examples of suitable diphenols are hydroquinone, resorcinol, dihydroxybiphenyl, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl)diisopropylbenzenes, and also the ring-halogenated, ring-alkylated, and other alkylated derivatives of these.

Preferred diphenols are 4,4′-dihydroxyvbiphenyl, 2,2-bis(4-hydroxyphenyl)-1-phenylpropane, 1,1-bis(4-hydroxyphenyl)phenylethane, 2,2-bis(4-hydroxyphenyl)propane, 2,4-bis(4-hydroxyphenyl)-2-methylbutane, 1,3-bis[2-(4-hydroxyphenyl)-2-propyl]benzene (bisphenol M), 2,2-bis(3-methyl-4-hydroxyphenyl)propane, bis(3,5-dimethyl-4-hydroxyphenyl)methane, 2,2-bis(3,5-dimethyl-4-hydroxyphenyl)propane, bis(3,5-dimethyl-4-hydroxyphenyl) sulfone, 2,4-bis(3,5-dimethyl-4-hydroxyphenyl)-2-methylbutane, 1,3-bis-[2-(3,5-dimethyl-4-hydroxyphenyl)-2-propyl]benzene, and 1,1-bis(4-hydroxyphenyl)-3,3,5-trimethylcyclohexane (bisphenol TMC), 1,1-bis(4-hydroxyphenyl)cyclohexane (bisphenol Z), 1,1-bis(3-methyl-4-hydroxyphenyl)cyclohexane (dimethyl BPZ).

Particularly preferred diphenols are 4,4′-dihydroxydiphenyl, 1,1-bis(4-hydroxyphenyl)phenylethane, 2,2-bis(4-hydroxyphenyl)propane, 2,2-bis(3-dimethyl-4-hydroxyphenyl)propane (dimethyl-BPA), 1,1-bis(4-hydroxyphenyl)cyclohexane 1,1-bis(3-methyl-4-hydroxyphenyl)cyclohexane (dimethyl BPZ), and 1,1-bis(4-hydroxyphenyl)-3,3,5-trimethylcyclohexane (bisphenol TMC).

These and other suitable dihydroxyaryl compounds are described by way of example in DE-A 3 832 396, FR-A 1 561 518, in H. Schnell, Chemistry and Physics of Polycarbonates, Interscience Publishers, New York 1964, pp. 28 ff.; pp. 102 ff., and in D. G. Legrand, J. T. Bendler, Handbook of Polycarbonate Science and Technology, Marcel Dekker New York 2000, pp. 72 ff.

In the case of the homopolycarbonates, only one diphenol is used, in the case of the copolycarbonates a plurality of diphenols are used, and it is self-evident here that the diphenols used, and also all of the other chemicals and auxiliaries added to the synthesis, can have contamination by contaminants deriving from the synthesis, handling, and storage of each of these; it is however desirable to operate with raw materials of the highest possible purity.

The interfacial process uses phosgene for the reaction with the dihydroxyaryl compounds.

The diaryl carbonates suitable for the reaction with the dihydroxyaryl compounds in the melt transesterification process are those of the general formula (II)

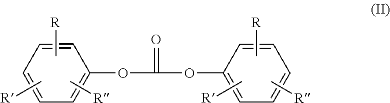

in which
R, R′, and R″ is mutually independently, identically or differently, hydrogen or linear or branched C₁-C₃₄-alkyl, C₇-C₃₄-alkylaryl, or C₆-C₃₄-aryl, and R can moreover also be —COO—R′″, where R′″ is hydrogen or linear or branched C₁-C₃₄-alkyl, C₇-C₃₄-alkylaryl, or C₆-C₃₄-aryl.

Preferred diaryl carbonates are by way of example diphenyl carbonate, di(methylphenyl) carbonates, di(4-ethylphenyl) carbonate, di(4-n-propylphenyl) carbonate, di(4-isopropylphenyl) carbonate, di(4-n-butylphenyl) carbonate, di(4-isobutylphenyl) carbonate, di(4-tritylphenyl) carbonate, di(methyl salicylate) carbonate, di(ethyl salicylate) carbonate, di(n-propyl salicylate) carbonate, di(isopropyl salicylate) carbonate, and di(n-butyl salicylate) carbonate, Particularly preferred diaryl compounds are diphenyl carbonate, di(4-tert-butylphenyl) carbonate, di(biphenyl-4-yl) carbonate, di[4-(1-methyl-1-phenylethyl)phenyl]carbonate, and di(methyl salicylate) carbonate.

Very particular preference is given to diphenyl carbonate (DPC).

It is possible to use either one diaryl carbonate or else various diaryl carbonates.

The diaryl carbonates can also be used with residual contents of the monohydroxyaryl compounds from which they have been produced. The residual contents of the monohydroxyaryl compounds can be up to 20% by weight, preferably up to 10% by weight, particularly preferably up to 5% by weight and very particularly preferably up to 2% by weight.

The quantity used of the diaryl carbonate(s), based on the dihydroxyaryl compound(s), is generally from 1.02 to 1.30 mol, preferably from 1.04 to 1.25 mol, particularly preferably from 1.045 to 1.22 mol, very particularly preferably from 1.05 to 1.20 mol, per mole of dihydroxyaryl compound. It is also possible to use mixtures of the abovementioned diaryl carbonates, and the molar data listed above per mole of dihydroxyaryl compound then relate to the total molar quantity of the mixture of the diaryl carbonates.

Branching agents or branching agent mixtures are optionally added in the same way to the synthesis. However, branching agents are usually added before the chain terminators. Compounds generally used are trisphenols, quaterphenols, or acyl chlorides of tri- or tetracarboxylic acids, or mixtures of the polyphenols or of the acyl chlorides. Examples of some of the compounds suitable as branching agents, having three or more phenolic hydroxy groups, are phloroglucinol, 4,6-dimethyl-2,4,6-tri(4-hydroxyphenyl)hept-2-ene, 4,6-dimethyl-2,4,6-tri(4-hydroxyphenyl)heptane, 1,3,5-tri(4-hydroxyphenyl)benzene, 1,1,1-tri(4-hydroxyphenyl)ethane, tri(4-hydroxyphenyl)phenylmethane, 2,2-bis(4,4-bis(4-hydroxyphenyl)cyclohexyl]propane, 2,4-bis(4-hydroxyphenylisopropyl)phenol, tetra(4-hydroxyphenyl)methane.

Some of the other trifunctional compounds are 2,4-dihydroxybenzoic acid, trimesic acid, cyanuric chloride, and 3,3-bis(3-methyl-4-hydroxyphenyl)-2-oxo-2,3-dihydroindole.

Preferred branching agents are 3,3-bis(3-methyl-4-hydroxyphenyl)-2-oxo-2,3-dihydroindole and 1,1,1-tri(4-hydroxyphenyl)ethane.

Catalysts that can be used in the melt transesterification process for the production of polycarbonates are basic catalysts known from the literature that are solid at room temperature (25° C.), for example alkali metal hydroxides, alkaline earth metal hydroxides, alkali metal oxides, and alkaline earth metal oxides, and/or onium salts, such as ammonium salts or phosphonium salts. The synthesis preferably uses onium salts, particularly phosphonium salts. Examples of these phosphonium salts are those of the general formula (IV)

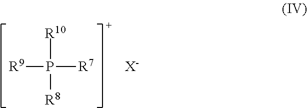

in which
R⁷⁻¹⁰ are identical or different optionally substituted C₁-C₁₀-alkyl, C₆-C₁₄-aryl, C₇-C₁₅-arylalkyl, or C₅-C₆-cycloalkyl moieties, preferably methyl or C₆-C₁₄-aryl, particularly preferably methyl or phenyl, and
X⁻ are an anion selected from the group of hydroxide, sulfate, hydrogensulfate, hydrogencarbonate, carbonate, halide, preferably chloride, and alkylate or arylate of the formula —OR¹¹, where R¹¹ is an optionally substituted C₆-C₁₄-aryl, C₇-C₁₅-arylalkyl or C₅-C₆-cycloalkyl moiety, or C₁-C₂₀-alkyl, preferably phenyl.

For the purposes of the invention, C₁-C₄-alkyl is by way of example methyl, ethyl, n-propyl, isopropyl, n-butyl, sec-butyl, tert-butyl, C₁-C₆-alkyl is moreover by way of example n-pentyl, 1-methylbutyl, 2-methylbutyl, 3-methylbutyl, neopentyl, 1-ethylpropyl, cyclohexyl, cyclopentyl, n-hexyl, 1,1-dimethylpropyl, 1,2-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, or 1-ethyl-2-methylpropyl, C₁-C₁₀-alkyl is moreover by way of example n-heptyl and n-octyl, pinacyl, adamantyl, the isomeric menthyl moieties, n-nonyl, n-decyl, and C₁-C₃₄-alkyl is moreover by way of example n-dodecyl, n-tridecyl, n-tetradecyl, n-hexadecyl, or n-octadecyl. The same applies to the corresponding alkyl moiety by way of example in aralkyl or alkylaryl, alkylphenyl, or alkylcarbonyl moieties. Alkylene moieties in the corresponding hydroxyalkyl or aralkyl or alkylaryl moieties are by way of example the alkylene moieties corresponding to the above alkyl moieties.

Aryl is a carbocyclic aromatic moiety having from 6 to 34 carbon atoms in the skeleton. The same applies to the aromatic portion of an arylalkyl moiety, also termed aralkyl moiety, and also to aryl constituents of more complex groups, e.g. arylcarbonyl moieties.

Examples of C₆-C₃₄-aryl are phenyl, o-, p-, m-tolyl, naphthyl, phenanthrenyl, anthracenyl, and fluorenyl.

Arylalkyl or aralkyl means in each case independently a straight-chain, cyclic, branched, or unbranched alkyl moiety as defined above which can have substitution by one or more aryl moieties as defined above, or can be fully substituted thereby.

Particularly preferred catalysts are tetraphenylphosphonium chloride, tetraphenylphosphonium hydroxide, and tetraphenylphosphonium phenolate, and very particular preference is given to tetraphenylphosphonium phenolate.

The quantities preferably used for the catalysts, based on one mole of dihydroxyaryl compound, are from 10⁻⁸ to 10⁻³ mol, particularly preferably from 10⁻⁷ to 10⁻⁴ mol.

It is optionally also possible to use cocatalysts in order to increase the polycondensation rate.

These can by way of example be alkaline salts of alkali metals and of alkaline earth metals, for example hydroxides, and optionally substituted C₁-C₁₀-alkoxides and C₆-C₁₄-aryloxides of lithium, sodium, and potassium, preferably hydroxides and optionally substituted C₁-C₁₀-alkoxides or C₆-C₁₄-aryloxides of sodium. Preference is given to sodium hydroxide, sodium phenolate, or the disodium salt of 2,2-bis(4-hydroxyphenyl)propane.

If alkali metal ions or alkaline earth metal ions are added in the form of salts thereof, the quantity of alkali metal ions or of alkaline earth metal ions, determined by way of example via atomic absorption spectroscopy, is from 1 to 500 ppb, preferably from 5 to 300 ppb, and most preferably from 5 to 200 ppb, based on polycarbonate to be formed. However, preferred embodiments of the process of the invention use no alkali metal salts.

Synthesis of polycarbonate in the interfacial process can be carried out continuously or batchwise. The reaction can therefore take place in stirred tanks, tubular reactors, pumped-circulation reactors, or stirred-tank cascades, or a combination thereof. It is necessary here to ensure, by using the mixing units already mentioned, that aqueous and organic phase do not demix before reaction of the synthesis mixture has been completed, i.e. that the synthesis mixture comprises no residual saponifiable chlorine in phosgene or in chloroformic esters.

After introduction of the phosgene in the interfacial process it can be advantageous to mix the organic phase and the aqueous phase for a certain time before addition optionally of branching agent, to the extent that this is not added together with the bisphenolate, and of chain terminator and catalyst. A continued-reaction time of this type can be advantageous after each addition. These continued-stirring times are from 10 seconds to 60 minutes, preferably from 30 seconds to 40 minutes, particularly preferably from 1 to 15 minutes.

The organic phase can be composed of one solvent or of a mixture of a plurality of solvents. Suitable solvents are chlorinated hydrocarbons (aliphatic and/or aromatic), preferably dichloromethane, trichloroethylene, 1,1,1-trichloroethane, 1,1,2-trichloroethane, and chlorobenzene, and mixtures of these. However, it is also possible to use aromatic hydrocarbons such as benzene, toluene, m/p/o-xylene, or aromatic ethers such as anisole alone, or in a mixture with, or in addition to, chlorinated hydrocarbons. Another embodiment of the synthesis uses solvents which merely swell, but do not dissolve, polycarbonate. It is therefore also possible to use non-solvents for polycarbonate in combination with solvents. Other solvents that can be used here are those soluble in the aqueous phase, for example tetrahydrofuran, 1,3/1,4-dioxane, or 1,3-dioxolane, when the solvent partner forms the second organic phase.

The monofunctional chain terminators required for molecular weight regulation, for example phenol or alkylphenols, in particular phenol, p-tert-butylphenol, isooctylphenol, cumylphenol, chloroformic esters of these, or acyl chlorides of monocarboxylic acids, or mixtures of said chain terminators, are either introduced into the reaction with the bisphenolate(s) or else added to the synthesis at any desired juncture, as long as phosgene or terminal chloroformic groups are still present in the reaction mixture or, in the case of the acyl chlorides and chloroformic esters as chain terminators, as long as a sufficient quantity of terminal phenolic groups of the resultant polymer are available. However, it is preferable that the chain terminator(s) is/are added after the phosgenation at a location or at a juncture where no residual phosgene is present, but addition of the catalyst has not yet taken place. They can alternatively also be added before the catalyst, together with the catalyst, or in parallel.

The catalysts preferably used in the interfacial synthesis of polycarbonate are tertiary amines, in particular triethylamine, tributylamine, trioctylamine, N-ethylpiperidine, N-methylpiperidine, N-iso/n-propylpiperidine, quaternary ammonium salts such as tetrabutylammonium, tributylbenzylammonium, tetraethylammonium hydroxide, chloride, bromide, hydrogensulfate, or tetrafluoroborate, or else the phosphonium compounds corresponding to the ammonium compounds. These compounds are described in the literature as typical interfacial catalysts, and are obtainable commercially, and are familiar to the person skilled in the art. The catalysts can be added to the synthesis individually, in a mixture, or else alongside one another, or in succession, optionally also prior to phosgenation, but preference is given to additions after phosgene introduction, unless an onium compound or a mixture of onium compounds are used as catalysts. In this case, preference is given to addition prior to phosgene addition. The catalyst(s) can be added undiluted, or in an inert solvent, preferably in the polycarbonate-synthesis solvent, or else in the form of aqueous solution, or in the case of the tertiary amines in the form of ammonium salts thereof with acids, preferably mineral acids, in particular hydrochloric acid. When a plurality of catalysts is used, or partial quantities of the total quantity of catalysts are added, it is naturally also possible to use different modes of addition at different locations or at different times. The total quantity of the catalysts used is from 0.001 to 10 mol %, based on mole of bisphenols used, preferably from 0.01 to 8 mol %, particularly preferably from 0.05 to 5 mol %.

Once the at least two-phase reaction mixture has completed its reaction, it comprises at most traces (<2 ppm) of chloroformic esters, and it is allowed to settle, for phase separation. The aqueous alkaline phase is possibly returned entirely or to some extent as aqueous phase to the polycarbonate synthesis, or else is sent for wastewater treatment, where solvent fractions and catalyst fractions are removed and returned. In another treatment variant, after removal of the organic contaminants, in particular of solvents and polymer residues, and optionally after adjustment to a particular pH, e.g. via addition of aqueous sodium hydroxide solution, the salt is removed and by way of example can be passed to the chloralkali electrolysis process, while the aqueous phase is optionally returned to the synthesis.

The organic phase comprising the polycarbonate can then be purified to remove all alkaline, ionic, or catalytic contaminants. Even after one or more settlement procedures, the organic phase retains fractions of the aqueous alkaline phase in fine droplets, and also retains the catalyst, generally a tertiary amine. The settlement procedures can optionally be assisted by passing the organic phase through settlement tanks, stirred tanks, coalescers, or separators, or combinations thereof, and in some circumstances here it is optionally possible to add water in all or some separations with use of active or passive mixing units.

After this removal of most of the alkaline, aqueous phase, the organic phase is washed one or more times with dilute acids, mineral acids, carboxylic acids, hydroxycarboxylic acids, and/or sulfonic acids. Preference is given to aqueous mineral acids, in particular hydrochloric acid, phosphorus acid, and phosphoric acid, or a mixture of these acids. The concentration of these acids should be in the range from 0.001 to 50% by weight, preferably from 0.01 to 5% by weight.

The organic phase is moreover repeatedly washed with deionized or distilled water. The separation of the organic phase, sometimes dispersed with fractions of the aqueous phase, is achieved after the individual washing steps by means of settling tanks, stirred tanks, coalescers, or separators, or a combination thereof, and between the washing steps here the wash water can optionally be added with use of active or passive mixing units.

Between said washing steps, or else after washing, it is optionally possible to add acids, preferably dissolved in the solvent on which the polymer solution is based. It is preferable here to use hydrogen chloride gas and phosphoric acid or phosphorus acid, and these can optionally also be used in the form of mixtures.

The above lists are examples and are not to be understood as limiting.

For the purposes of the present invention—unless otherwise stated—ppb and ppm mean parts by weight.

The average molecular weight, determined via gel permeation chromatography, of the polycarbonate of the invention used can be from 5000 to 80 000, preferably from 10 000 to 60 000, and most preferably from 15 000 to 40 000.

### Component B

Component B is a phosphorus-based ionic liquid that is molten at room temperature (25° C.).

Ionic liquids used in the invention are preferably compounds of the general formula (I), present at a concentration of from 0.05 to 8 parts by weight, preferably from 0.1 to 5 parts by weight, particularly preferably from 0.15 to 4 parts by weight, particularly preferably from 0.2 to 3 parts by weight, and very particularly preferably from 0.25 to 2.5 parts by weight (based on the sum of the parts by weight of components A and B) in (co)polycarbonate,

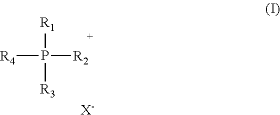

where R₁ to R₄ is mutually independently a substituted alkyl or aryl moiety.

Ionic liquids are composed exclusively of ion pairs. These are therefore liquid salts, where the salt here has not been dissolved in any solvent such as water. The expression ionic liquids preferably means salts which are liquid at temperatures below 100 C, particularly below 70° C., in particular below 50° C., very particularly below 30° C., and in particular below 28° C., and very particularly below 20° C.

X⁻ is a mono- or polyvalent anion, preferably mono, di, tri or tetravalent, for example halides, carboxylates, phosphates, bis(perfluoroalkylsulfonyl)amides or -imides, for example bis(trifluoromethylylsulfonyl)imide, alkyl- and aryltosylates, perfluoroalkyltosylates, nitrate, sulfate, hydrogensulfate, alkyl and aryl sulfates, polyether sulfates and polyether sulfonates, perfluoroalkyl sulfates, sulfonate, alkyl- and arylsulfonates, perfluorinated alkyl- and arylsulfonates, alkyl- and arylcarboxylates, perfluoroalkylcarboxylates, perchlorate, tetrarchloroaluminate, and saccharinate. Preferred anions are moreover dicyanamide, thiocyanate, isothiocyanate, tetraphenylborate, tetrakis(pentafluorophenyl)borate, tetrafluoroborate, hexafluorophosphate, polyether phosphates, and phosphate.

It is preferable that X⁻ is an anion selected from F⁻, Cl⁻, Br⁻, r, PF₆⁻, CF₃SO₃⁻, (CF₃SO₃)₂N⁻, CF₃CO₂⁻, CCl₃CO₂⁻, CN⁻, SCN⁻, OCN⁻; SO₄²⁻, HSO₄⁻, SO₃²⁻, HSO₃⁻, R^{a}OSO₃⁻, R^{a}SO₃⁻; PO₄³⁻, HPO₄²⁻, H₂PO₄⁻, R^{a}PO₄²⁻, HR^{a}PO₄⁻, R^{a}R^{b}PO₄⁻, R^{a}HPO₃⁻, R^{a}R^{b}PO₂⁻, R^{a}R^{b}PO₃⁻, PO₃³⁻, HPO₃²⁻, H₂PO₃⁻, R^{a}PO₃²⁻, R^{a}HPO₃⁻, R^{a}R^{b}PO₃⁻; R^{a}R^{b}PO₂⁻, R^{a}HPO₂⁻, R^{a}R^{b}PO⁻, R^{a}HPO⁻; R^{a}COO⁻, saccarinates (salts of o-benzoic sulfamide), formic acids, sugar acids, BO₃³⁻, HBO₃²⁻, H₂BO₃⁻, R^{a}R^{b}BO₃⁻, R^{a}HBO₃⁻, R^{a}BO₃²⁻, B(OR^{a})(OR^{b})(OR^{c})(OR^{d})⁻, B(HSO₄)⁻, B(R^{a}SO₄)⁻; R^{a}BO₂²⁻, R^{a}R^{b}BO⁻, HCO₃⁻, CO₃²⁻, R^{a}CO₃⁻, SiO₄⁴⁻, HSiO₄³⁻, H₂SiO₄²⁻, H₃SiO₄⁻, R^{a}SiO₄³⁻, R^{a}R^{b}SiO₄²⁻, R^{a}R^{b}R^{c}SiO₄⁻, HR^{a}SiO₄²⁻, H₂R^{a}SiO₄⁻, HR^{a}R^{b}SiO₄⁻; R^{a}SiO₃³⁻, R^{a}R^{b}SiO₂²⁻, R^{a}R^{b}R^{c}SiO₃⁻, R^{a}R^{b}R^{c}SiO₃⁻—, R^{a}R^{b}R^{c}SiO₂⁻, R^{a}R^{b}SiO₃²⁻; S²⁻, HS⁻, [R^{a}S]⁻

where R^{a}, R^{b}, R^{c}, or R^{d} is mutually independently a substituted alkyl or aryl moiety.

Alkyl is a straight-chain, cyclic, branched, or unbranched alkyl moiety, where the moieties mentioned can optionally have further substitution.

C₁-C₆-Alkyl is by way of example methyl, ethyl, n-propyl, isopropyl, n-butyl, sec-butyl, tert-butyl, n-pentyl, 1-methylbutyl, 2-methylbutyl, 3-methylbutyl, neopentyl, 1-ethylpropyl, cyclohexyl, cyclopentyl, n-hexyl, 1,1-dimethylpropyl, 1,2-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, or 1-ethyl-2-methylpropyl, C₁-C₁₈-alkyl is moreover by way of example is moreover by way of example n-heptyl and n-octyl, pinacyl, adamantyl, the isomeric menthyl moieties, n-nonyl, n-decyl, n-dodecyl, n-tridecyl, n-tetradecyl, n-hexadecyl, n-octadecyl, or stearyl.

Aryl is respectively independently an aromatic moiety having from 4 to 24 skeletal carbon atoms, where no, one, two or three skeletal carbon atoms per ring, but at least one skeletal carbon atom in the entire molecule, can have substitution by heteroatoms selected from the group of nitrogen, sulfur, and oxygen, but aryl is preferably a carbocyclic aromatic moiety having from 6 to 24 skeletal carbon atoms.

Examples of C₆-C₂₄-aryl are phenyl, o-, p-, m-tolyl, naphthyl, phenanthrenyl, anthracenyl, and fluorenyl, examples of heteroaromatic C₄-C₂₄-aryl where no, one, two, or three skeletal carbon atoms per ring, but at least one skeletal carbon atom in the entire molecule, can have substitution by heteroatoms selected from the group of nitrogen, sulfur, and oxygen are by way of example pyridyl, pyridyl-N-oxide, pyrimidyl, pyridazinyl, pyrazinyl, thienyl, furyl, pyrrolyl, pyrazolyl, imidazolyl, thiazolyl, oxazolyl, or isoxazolyl, indolizinyl, indolyl, benzo[b]thienyl, benzo[b]furyl, indazolyl, quinolyl, isoquinolyl, naphthyridinyl, quinazolinyl, benzofuranyl, or dibenzofuranyl.

Examples of phosphonium-based ionic liquids are ethyltributylphosphonium diethyl phosphates, tetrabutylphosphoniumbromide, tetrabutylphosphonium chloride, tetraoctylphosphoniumbromide, tributylmethylphosphonium methyl sulfate, tributyltetradecylphosphonium chloride, tributyltetradecylphosphonium dodecylbenzenesulfonate, trihexyltetradecylphosphonium bis(2,4,4-trimethylpentyl)phosphinate, trihexyltetradecylphosphoniumbromides trihexyltetradecylphosphonium chloride, trihexyltetradecylphosphonium decanoate, trihexyltetradecylphosphonium dicyanamide, and IL-AP3® from Koei Chemical Company Ltd. Particularly preferable is IL-AP3®.

In one preferred embodiment it is also possible to use a mixture of a plurality of ionic liquids, or else a single ionic liquid.

### Component C

Component C comprises phosphorus-based heat stabilizers and comprises light stabilizers based on various underlying chemical structures which are capable of absorbing electromagnetic radiation.

A preferred suitable heat stabilizer is tris(2,4-di-tert-butylphenyl)phosphite (Irgafos 168), tetrakis(2,4-di-tert-butylphenyl) [1,1biphenyl]-4,4′-diylbisphosphonite, triisoctyl phosphate (TOF), octadecyl 3-(3,5-di-tert butyl-4-hydroxyphenyl)propionate (Irganox 1076), bis(2,4-dicumylphenyl)pentaerythritol diphosphite (Doverphos S-9228), bis(2,6-di-tertbutyl-4-methylphenyl)pentaerythritol diphosphite (ADK STAB PEP-36) or triphenylphosphine (TPP). They are used alone or in a mixture (e.g. Irganox B900, a mixture of Irgafos 168 and Irganox 1076, or Doverphos S-9228 with Irganox B900 or Irganox 1076, or triphenylphosphine (TPP) with triisoctyl phosphate (TOF)), or tris(2,4-di-tert-butylphenyl)phosphite (Irgafos 168) with triisoctyl phosphate (TOF).

Quantities used of the heat stabilizers are from 10 ppm to 2000 ppm, based on the molding composition, preferably from 50 ppm to 1500 ppm, particularly preferably from 80 ppm to 1000 ppm, and very particularly preferably from 100 ppm to 800 ppm, based on the entire composition.

Suitable light stabilizers (UV absorbers) are 2-(2′-hydroxyphenyl)benzotriazoles, 2-hydroxybenzophenones, esters of substituted and unsubstituted benzoic acids, acrylates, sterically hindered amines, oxamides, and also 2-(hydroxyphenyl)-1,3,5-triazines or substituted hydroxyalkoxyphenyl, 1,3,5-triazoles, preference being given to substituted benzotriazoles such as 2-(2′-hydroxy-5′-methylphenyl)benzotriazole, 2-(2′-hydroxy-3′,5′-di-t-butyl-phenyl)benzotriazole, 2-(2′-hydroxy-3′-tert-butyl-5′-methylphenyl)-5-chlorobenzotriazole, 2-(2′-hydroxy-3′,5′-tert-butylphenyl)-5-chlorobenzotriazole, 2-(2′-hydroxy-5′-tert-octylphenyl)benzotriazole, 2-(2′-hydroxy-3′,5′-di-tert-amylphenyl)benzotriazole, 2-[2′-hydroxy-3′(3″,4″,5″,6″-tetrahydrophthalimidoethyl)-5′-methylphenyl]benzotriazole, and 2,2′-methylenebis[4-(1,1,3,3-tetramethylbutyl)-6-(2H-benzotriazol-2-yl)phenol].

Other suitable UV stabilizers are selected from the group which comprises benzotriazoles (e.g. Tinuvin products from BASF), Tinuvin 1600 from BASF, benzophenones (Uvinul products from BASF), cyanoacrylates (Uvinul products from BASF), cinnamic esters, and oxanilides, and also mixtures of these UV stabilizers.

Quantities used of the UV stabilizers are from 0.01% by weight to 2.0% by weight, based on the molding composition, preferably from 0.05% by weight to 1.00% by weight, particularly preferably from 0.08% by weight to 0.5% by weight, and very particularly preferably from 0.1% by weight to 0.4% by weight, based on the entire composition.

The present invention further provides compositions comprising abovementioned polycarbonate with ionic liquid or with a mixture thereof, and also with a heat stabilizer and optionally with a light stabilizer, and also optionally comprising at least one added substance selected from the group of the added substances conventionally used for these thermoplastics, for example fillers, antistatic agents, and pigments and colorants in the usual quantities; demolding behavior, rheology, and/or flame retardancy can optionally also be improved via addition of external mold-release agents, flow agents, and/or flame retardants, for example sulfonic salts, PTFE polymers, PTFE copolymers, or PTFE blends, brominated oligocarbonates, or oligophosphates, or else phosphazenes (e.g. alkyl and aryl phosphites and corresponding phosphates and phosphanes, low-molecular-weight carboxylic esters, halogen compounds, salts, chalk, powdered quartz, glass fibers and carbon fibers, pigments, and a combination of these. Compounds of this type are described by way of example in WO 99/55772, pp. 15-25, and in “Plastics Additives”, R. Gächter and H. Müller, Hanser Publishers 1983).

The composition generally comprises from 0% by weight to 25% by weight, preferably from 0% by weight to 15% by weight, particularly preferably from 0% by weight to 5% by weight, very particularly preferably from 0.04% by weight to 1.0% by weight, with very particular preference from 0.04% by weight to 0.8% by weight, of added substances (based on the entire composition).

The mold-release agents optionally added to the compositions of the invention are preferably selected from the group which comprises pentaerythritol tetrastearate, glycerol monostearate, long-chain fatty acid esters, such as stearyl stearate and propanediol stearate, and also mixtures of these. The quantities used of the mold-release agents are from 0.05% by weight to 2.00% by weight, based on the molding composition, preferably from 0.1% by weight to 1.0% by weight, particularly preferably from 0.15% by weight to 0.60% by weight, and very particularly preferably from 0.2% by weight to 0.5% by weight, based on the molding composition.

Suitable additional substances are described by way of example in “Additives for Plastics Handbook, John Murphy, Elsevier, Oxford 1999”, in “Plastics Additives Handbook, Hans Zweifel, Hanser, Munich 2001”.

Examples of suitable antioxidants are:

Alkylated monophenols, alkylthiomethylphenols, hydroquinones and alkylated hydroquinones, tocopherols, hydroxylated thiodiphenyl ethers, alkylidenebisphenols, O-, N-, and S-benzyl compounds, hydroxybenzylated malonates, aromatic hydroxybenzyl compounds, triazine compounds, acylaminophenols, esters of β-(3,5-di-tert-butyl-4-hydroxyphenyl)propionic acid, esters of β-(5-tert-butyl-4-hydroxy-3-methylphenyl)propionic acid, esters of β-(3,5-dicyclohexyl-4-hydroxyphenyl)propionic acid, esters of 3,5-di-tert-butyl-4-hydroxyphenylacetic acid, amides of 13-(3,5-di-tert-butyl-4-hydroxyphenyl)propionic acid, suitable thiosynergists, secondary antioxidants, phosphites and phosphonites, benzofuranones and indolinones.

Suitable complexing agents for heavy metals and for the neutralization of traces of alkalis are o/m phosphoric acids, and completely or partially esterified phosphates or phosphites.

Polypropylene glycols alone or in combination with, for example, sulfones, or with sulfonamides, can be used as stabilizers to counter damage due to gamma radiation.

These and other stabilizers can be used individually or in combination, and can be added in the forms mentioned to the polymer.

Suitable added flame-retardant substances are phosphate esters, i.e. triphenyl phosphate, resorcinol diphosphate, bromine-containing compounds, such as brominated phosphoric esters, brominated oligocarbonates and polycarbonates, and also preferably salts of fluorinated organic sulfonic acids.

Suitable impact modifiers are butadiene rubber with grafted-on styrene-acrylonitrile or methyl methacrylate, ethylene-propylene rubbers with grafted-on maleic anhydride, ethyl and butyl acrylate rubbers with grafted-on methyl methacrylate or styrene-acrylonitrile, and interpenetrating siloxane and acrylate networks with grafted-on methyl methacrylate or styrene-acrylonitrile.

It is moreover possible to add colorants such as organic dies or pigments, or inorganic pigments, carbon black, or IR absorbers, individually, in a mixture, or else in combination with stabilizers, with glass fibers, with (hollow) glass spheres, or with inorganic fillers such as titanium dioxide or barium sulfate.

In one preferred embodiment, the composition comprises no conductive salts. Conductive salts are by way of example alkali metal salts with the anions bis(perfluoroalkylsulfonyl)amide or -imide, for example bis(trifluoromethylsulfonyl)imide, alkyl- and aryltosylates, perfluoroalkyltosylates, nitrate, sulfate, hydrogensulfate, alkyl and aryl sulfates, polyether sulfates and polyether sulfonates, perfluoroalkyl sulfates, sulfonate, alkyl- and arylsulfonates, perfluorinated alkyl- and arylsulfonates, alkyl- and arylcarboxylates, perfluoroalkylcarboxylates, perchlorate, tetrachloroaluminate, and saccharinate, thiocyanate, isothiocyanate, dicyanamide, tetraphenylborate, tetrakis(pentafluorophenyl)borate, tetrafluoroborate, hexafluorophosphate, phosphate, and polyether phosphates.

The compositions of the invention can by way of example be produced by mixing the respective constituents in a known manner and compounding them in the melt at temperatures of from 200° C. to 400° C. in conventional assemblies such as extruders, internal mixers, and twin-screw machinery, and extruding the same in the melt. The mixing of the individual constituents can take place either in succession or else simultaneously, and specifically either at about 20° C. or at higher temperature. However, the compounds used in the invention can also be introduced separately in different stages of the production process into the melt-polycarbonate molding composition: by way of example, the ionic liquid(s) can be introduced into the melt polycarbonate during or at the end of the transesterification of bisphenols with organic carbonates, before or during the formation of oligomeric polycarbonates, or before or after the polycondensation of the MPC oligomers. It is also possible if desired to add the ionic liquid(s) as finished mixture together with other additives to the MPC at any desired point. It is also possible to reverse the above sequence of addition of the components.

The compounds of the invention can be added in any desired form. The compounds of the invention, or mixtures of the compounds of the invention, can be added as concentrate in polycarbonate powder, in solution, or as melt to the polymer melt. It is preferable that the ionic liquid(s) is/are added by way of a melt-metering pump or by way of an ancillary extruder behind the final polycondensation stage. In industrial embodiments, it is particularly preferable to operate an ancillary extruder with a throughput of, for example, from 200 to 1000 kg of polycarbonate per hour.

In one preferred embodiment, ionic liquid is added by way of example at room temperature in liquid form together with polycarbonate into the hopper of the polycarbonate input of the ancillary extruder. The quantity of ionic liquid is metered by way of example with the aid of a membrane pump or of any other suitable pump. It is preferable that ionic liquid or mixtures of ionic liquids is/are added in liquid form at a temperature of about 40 to 250° C. behind the hopper of the polycarbonate input into an extruder zone equipped with mixing elements. The ionic liquid or mixture of ionic liquids here is taken from a ring line which is preferably kept at a pressure of from 2-20 bar, preferably at a temperature of from 40 to 250° C. The quantity added can be controlled by way of a control valve.

In one particularly preferred embodiment there is, behind the ancillary extruder and all of the additive addition points, a static mixer for ensuring good mixing of all of the additives. The polycarbonate melt from the ancillary extruder is then introduced into the main polycarbonate melt stream. The mixing of the main melt stream with the melt stream from the ancillary extruder is achieved by way of a further static mixer.

As an alternative to the addition of liquid, it is possible to add the ionic liquids in the form of a masterbatch (concentrate of the additives in polycarbonate) by way of the hopper of the polycarbonate input of the ancillary extruder. This masterbatch can comprise other additives.

The ionic liquids and optionally other additives can also be introduced subsequently into the polycarbonate, by way of example via compounding.

The molding compositions of the invention can be used for the production of moldings of any type. These can by way of example be produced via injection molding, extrusion, and blow molding processes. Another type of processing is the production of moldings via thermoforming from prefabricated sheets or foils.

Examples of the moldings of the invention are profiles, foils, housing parts of any type, e.g. for household equipment such as juice presses, coffee machines, mixers; for office machinery such as monitors, printers, copiers; for sheets, pipes, electrical installation ducts, windows, doors, and profiles for the construction sector, indoor fittings, and external applications; in the electrical engineering sector by way of example for switches and plugs. The moldings of the invention can moreover be used for internal-external and components of rail vehicles, of ships, of aircraft, of buses, and of other motor vehicles, and also for bodywork parts of motor vehicles.

The moldings of the invention can be transparent, translucent, or opaque. Other moldings are in particular optical and magneto-optical data storage systems such as mini-disk, compact disk (CD), or digital versatile disk (DVD), food packaging and drinks packaging, optical lenses and prisms, lenses for lighting purposes, automobile headlamp lenses, glazing for construction and motor vehicles, panels of other types, for example for greenhouses, and what are known as twin-web sandwich panels or hollow panels, (helmet) visors, protective masks, or automated equipment.

### EXAMPLES

The examples below illustrate the invention, but with no resultant restriction.

### YI and Subsequent Yellowing (ΔYI)

Optical properties of the molding compositions of the invention are determined via measurement of what is known as the Yellowness Index (YI) on standard test specimens in accordance with ASTM E313. These standard test specimens are color sample plaques (80×10×3 mm) which were produced from the (co)polycarbonate compositions at a melt temperature of 300° C. and a mold temperature of 90° C.

### MVR

The melt volume flow rate (MVR) is determined at 300° C. with 1.2 kg load with melt index testing equipment in accordance with ISO 1133. The IMVR value corresponds to the MVR value, but after 20 minutes of thermal stress under the stated conditions.

### Production of the Compositions of the Invention

The compounded materials of the invention were produced in a ZE 25 extruder from Baersdorf, with a throughput of 10 kg/hour. The melt temperature was 275° C. The additive were admixed with the polycarbonate powder (PC-B, see below for raw materials used), and this mixture was metered into the polycarbonate PC-A.

### Raw Materials Used:

PC A is a linear, heat-stabilized polycarbonate without additives from Bayer MaterialScience AG, Leverkusen, based on bisphenol-A with a melt volume rate MVR of 12.5 cm³/10 min (measured by a method based on DIN EN ISO 1133 for 1.2 kg load and 300° C.)

PC B is a linear polycarbonate from Bayer MaterialScience AG, Leverkusen without additives, based on bisphenol A with an MVR of 6 cm³/10 min min (measured by a method based on DIN EN ISO 1133 for 1.2 kg load and 300° C.) in powder form

IL-AP3® is an ionic liquid from Koei Chemical Company Ltd, based on a phosphonium salt with a glass transition temperature of −78.5° C. and with a melting point of 18° C., and with a viscosity of 338 mPa·s at 25° C. The refractive index is 1446.

TABLE 1

| | | PC-1 | PC-2 | PC-3 | PC-4 |
|---|---|---|---|---|---|
| Formulation | | | | | |
| PC-A | % | 93 | 93 | 93 | 93 |
| PC-B powder | % | 7.0 | 6.8 | 6.6 | 6.0 |
| IL-AP3 ® | % | — | 0.2 | 0.4 | 1.0 |
| Tests: | | | | | |
| MVR | ml/10 min | 9.9 | 10.6 | 10.9 | 11.9 |
| IMVR20′ | ml/10 min | 10.7 | 10.9 | 11.4 | 12.1 |
| ΔMVR/IMVR20′ | | 0.8 | 0.3 | 0.5 | 0.2 |
| Vicat VSTB 50 | ° C. | 147 | 147 | 145 | 143 |
| Notched impact | | | | | |
| resistance ISO7391 | | | | | |
| for 3 mm | | | | | |
| 23° C. | kJ/m² | 62z | 64z | 64z | 64z |
| 10° C. | kJ/m² | 62z | 63z | 63z | 64z |
| 0° C. | kJ/m² | 60z | 59z | 61z | 9 × 60z |
| | | | | | 1 × 21s |
| Optical properties | | | | | |
| Transmittance | | 89.3 | 89.3 | 89.3 | 89.2 |
| Haze | | 0.27 | 0.41 | 0.36 | 0.33 |
| Yellowness Index | | 2.03 | 1.68 | 1.92 | 1.91 |

Notched impact resistance in accordance with IDO 7391 is determined in each case on 10 test specimens measuring 80×10×3 mm, The values correspond to the average value from 10 tests, and unless otherwise indicated. s means brittle fracture; z means ductile failure

As shown by the examples PC-2 to PC-4 of the invention, addition of the ionic liquid IL-AP3® significantly reduces the Yellowness Index YI of the compounded materials in comparison with the blind specimen PC-1. Flowability is simultaneously improved, without any impairment of melt stability. The Vicat point here is only insignificantly lowered. The good mechanical properties are retained without alteration.

1.-8. (canceled)

9. A composition comprising
A) one or more aromatic polycarbonate(s) or copolycarbonate(s);
B) from 0.05 to 8 parts by weight, based on the sum of the parts by weight of A and B, of a phosphorus-containing ionic liquid of the formula (I) 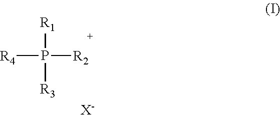
where each of R₁ to R₄ is mutually independently a substituted alkyl or aryl moiety; and
C) from 10 ppm to 2000 ppm of at least one additive from the group of phosphorus-based heat stabilizers.

10. The composition as claimed in claim 9, wherein a further additive is present, which further additive is a light stabilizer.

11. The composition as claimed in claim 9, wherein the polycarbonate is a bisphenol-A-based polycarbonate.

12. The composition as claimed in claim 9, wherein the heat stabilizers are selected from the group of tris(2,4-di-tert-butylphenyl)phosphite (Irgafos 168), tetrakis(2,4-di-tert-butylphenyl) [1,1biphenyl]-4,4′-diylbisphosphonite, triisoctyl phosphate (TOF), octadecyl 3-(3,5-di-tert butyl-4-hydroxyphenyl)propionate (Irganox 1076), bis(2,4-dicumylphenyl)pentaerythritol diphosphite (Doverphos S-9228), bis(2,6-di-tertbutyl-4-methylphenyl)pentaerythritol diphosphite (ADK STAB PEP-36) or triphenylphosphine (TPP).

13. The composition as claimed in claim 9, wherein the at least one phosphorus-based heat stabilizer comprises a mixture of heat stabilizers from the class of phosphates, phosphites, and sterically hindered phenols.

14. The composition as claimed in claim 9, wherein the composition comprises further additives and/or fillers.

15. A molding comprising a composition as claimed in claim 9.

16. A transparent molding comprising a composition as claimed in claim 9.

17. The composition as claimed in claim 9, wherein B is present in the amount from 0.1 to 5 parts by weight based on the sum of the parts by weight of A and B.

18. The composition as claimed in claim 9, wherein B is present in the amount 0.15 to 4 parts by weight based on the sum of the parts by weight of A and B.

19. The composition as claimed in claim 9, wherein B is present in the amount from 0.2 to 3 parts by weight based on the sum of the parts by weight of A and B.

20. The composition as claimed in claim 9, wherein B is present in the amount from 0.25 to 2.5 parts by weight based on the sum of the parts by weight of A and B.

21. The transparent molding according to claim 16, contained in an optical component, a protective cover for an optical component, a foil, a sheet, a lens, a housing, an automobile glazing element or an architectural glazing element.
